(19) United States
(12) Patent Application Publication
(10) Pub. No.: US 2019/0274368 A1
(43) Pub. Date: Sep. 12, 2019

(54) DISPOSABLE BURPING CLOTH AND BIB

(71) Applicant: ENNOVATE PRODUCTS LLC, Irvine, CA (US)

(72) Inventors: Chi-Pao Liao, Irvine, CA (US); Ani Gioibalyan, Irvine, CA (US)

(21) Appl. No.: 16/219,916

(22) Filed: Dec. 13, 2018

Related U.S. Application Data
(60) Provisional application No. 62/598,412, filed on Dec. 13, 2017.

(51) Int. Cl. A41B 13/10; B32B 5/02; B32B 5/26

(52) U.S. Cl. CPC A41B 13/10; B32B 5/022; B32B 5/024; B32B 5/26; A41B 2500/20; A41B 2500/30; B32B 2437/00; A41B 2500/50; A41B 2400/52; B32B 2262/0253; B32B 2307/726; B32B 2307/7265; A41B 2400/60

(57) ABSTRACT

A burping bib formed from a panel of material which can be used as both a bib and as a burping cloth, the burping bib having a central opening and opposing longitudinal ends, with the front portion of the panel being longer than the rear portion.

### CROSS-REFERENCE TO RELATED APPLICATIONS

This application claims the benefit of priority under 35 U.S.C. § 120 from U.S. Patent Application No. 62/598,412, filed Dec. 13, 2017, the disclosure of which application is incorporated herein by reference in its entirety.

### BACKGROUND

Infants take nutrition initially in liquid form, either through nursing or bottle feeding, and in the process of doing so sometimes ingest air. Air that's entered the esophagus or stomach of an infant is eventually expelled through burping, and in the process some of the solid and/or liquid contents of the infant's stomach can also be expelled, leading to soiling of the clothing of the infant and of an adult caregiver holding or otherwise near the infant. Burp cloths may be worn by adult caretakers to protect the caretaker's clothing, by forming a barrier between regurgitated solids or liquids and the clothing of the caretaker.

Bibs may be worn by infants while they are fed solid or semisolid foods in order to protect their clothing. Baby bibs generally include a front portion having a width approximately the same as, or slightly wider than, an infant with whom it is intended to be used. The front portion extends downwardly from an upper end near the infant's neck (when being worn) to a lower edge, which may extend to the infant's waist or lap. The upper end of the bib further includes two straps, one on either lateral side, which can be tied together behind the infant's neck in order to secure the bib to the infant.

### SUMMARY

The present invention provides a disposable, single-panel article which can be used as both a bib and as a burping cloth. The present burping bib is formed from an elongated panel made from a piece of flexible material. It has a right side, a left side, a top end with a top edge, a bottom end with a bottom edge, an upper surface, a lower surface, a front portion, a central portion, and a rear portion. The central portion of the bib has an opening with a circumferential edge sized to accommodate the neck of an infant user and a slit between the opening and the right side or left side of the panel. The rear portion of the bib extends longitudinally from the top edge of the panel to the circumferential edge of the opening of the central portion, with the top edge preferably being separated from the circumferential edge by a distance of between about 4 inches and about 12 inches, preferably by between about 5 inches and about 9 inches, for example by about 6 inches. The front portion of the bib extends longitudinally from the bottom edge of the panel to the circumferential opening of the central portion, with the bottom edge being separated from the circumferential edge by a distance of between about 5 inches and about 15 inches, preferably by between about 7 inches and about 12 inches, for example by about 8 inches. The longitudinal extent of the front portion of the bib is preferably greater than the longitudinal extent of the rear portion by between about 20% and about 30%.

The central portion of the bib can include a plurality of slits between the opening and the right side or left side of the panel, preferably arranged in series in the manner of perforations. The perforations can extend from the circumferential edge to the right or left side. The circumferential edge can have a diameter of about 5 inches, for example. Preferably, the upper and/or lower side of the panel have a width greater than a width of the central portion. The bib preferably also includes only radiused edges, to avoid injury to an infant user.

The present burping bib can be made from a variety of materials, and in one embodiment can include an absorbent material to aid in containing regurgitated matter. In this embodiment, the panel of the bib can include an upper layer made from an absorbent material and a lower layer made from a water-resistant material. The bibs can be formed individually, or a plurality of the burping bibs can be provided as an assembly of bibs, with each of the bibs joined to at least one other bib. Such an assembly of bibs can be joined in series, and can be wound around a spindle to form a roll of bibs.

### FIGURES

FIG. 1 is a top plan view of the front side of an embodiment of the present burping bib.

FIG. 2 is a top plan view of the rear side of the burping bib of FIG. 1.

FIG. 3 is a top plan view of the rear side of the burping bib of FIG. 1, illustrating dimensions of the present burping bib.

FIG. 4 is a top plan view of the rear side of another embodiment of the present burping bib.

FIG. 5 is a top plan view of the rear side of a further embodiment of the present burping bib.

FIG. 6 is a front elevation view of an infant user wearing the burping bib of FIG. 1.

FIG. 7 is a perspective view of an adult user holding an infant wearing the present burping bib.

The reference numbers in the figures designate the following components of the present burping bib:

| | | Reference |
|---|---|---|
| Component | Subcomponent | Number |
| bib | | 10 |
| first sheet | | 8 |
| second sheet | | 9 |
| assembly of bibs | | 11 |
| panel | | 15 |
| | right side | 12 |
| | left side | 14 |
| | top end | 16 |
| | top edge | 17 |
| | bottom end | 18 |
| | bottom edge | 19 |
| | upper surface | 22 |
| | lower surface | 24 |
| bib central portion | | 25 |
| opening | | 30 |
| | circumferential | 32 |
| | edge | |
| | slit | 34 |
| bib front portion | | 36 |
| bib rear portion | | 38 |
| perforation line | | 40 |
| | perforation | 42 |
| child user | | 40 |
| adult user | | 50 |

### DESCRIPTION

### Definitions

As used herein, the following terms and variations thereof have the meanings given below, unless a different meaning is clearly intended by the context in which such term is used.

“About” and “approximately” refer to a quantity within 10% of the referenced quantity, unless the circumstances of such usage would indicate a different meaning.

“Bib” refers to a piece of material which extends downwardly from a user's neck and is fastened around the user's neck, in order to keep the user's clothes clean while eating.

“Burping cloth” generally refers to a piece of material sized to cover at least a portion of an infant caregiver's shoulder to protect the caregiver's clothing in case an infant regurgitates milk after feeding.

“Elongated” and “longitudinal” refer to a configuration or shape having a length which is longer than its width.

“Panel” refers to a section or piece of flexible material, such as fabric, extending over or covering a predetermined area. Panels are generally relatively thin as compared to the extent of their length and width.

“Perforation” refers to one or more cuts or holes made in a panel.

“Slit” refers to a cut or opening between two adjacent edges of a panel. The edges can be in contact at the slit portion, or can be separated by a relatively short distance. Perforations are a series of slits, and when the material between adjacent perforations is torn, the perforations form a longer slit.

The terms “upper,” “lower,” “top”, “bottom, “outer,” “inner,” “right,” “left,” and similar terms will be used to designate areas and positions of portions of the present article, but it is to be understood that these terms are relative and are not absolute terms. “Right” and “left” will thus be used to designate opposing lateral sides of components of the present article of manufacture, for example, and “upper” and “lower” will likewise be used to designate opposing faces or sides of the present article, and will be understood to be relative terms.

The term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise. Ranges which are described as being “between” two values include the indicated values.

### Burping Cloth Bib

The present article of manufacture, generally referred to as a burping cloth bib (or simply a “bib”) 10 consists of a panel 15 of material having a first lateral side (right side) 12, a second lateral side (left side) 14, a first longitudinal side (top end) 16, a second longitudinal side (bottom end) 18, a front side (upper surface) 22, and a rear side (lower surface) 24. When multiple layers of material are used in the panel 15, the front surface 22 and lower surface 24 refer to the surfaces on the exterior of the bib 10. The two opposing longitudinal sides 16 and 18 are preferably flared, i.e. wider than a central portion 25 of the panel 15. Such flaring preferably comprises a gradually widening from the central portion 25 to a respective longitudinal end of the panel 15. This is to provide greater surface area in lower, covered areas when the bib 10 is worn by an infant user. The lower edges of longitudinal sides 16 and 18, i.e. where longitudinal sides 16 and 18 meet the lateral sides 12 and 14, are preferably rounded or radiused, in order to avoid the possibility of a sharp corner that could potentially injure the delicate skin of an infant.

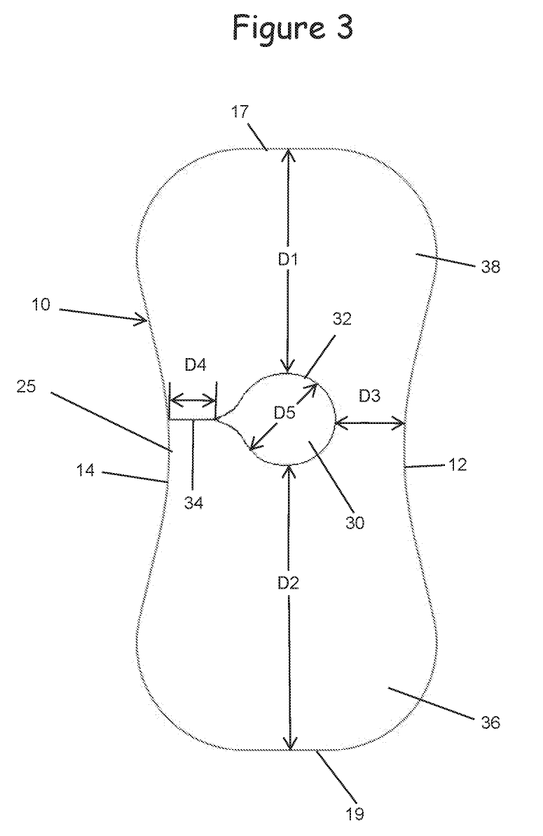

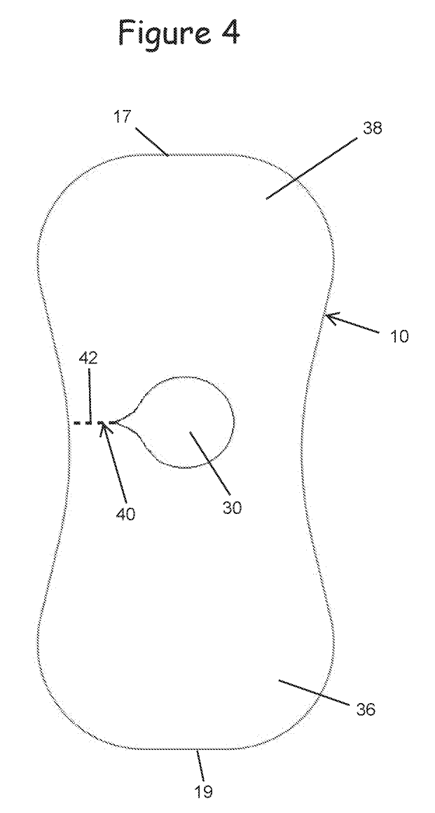

In the center portion 25 of the panel 15 is an opening 30 defined by a circumferential edge 32, which can be generally circular, oval, or of other, preferably smooth-edged shapes. The opening 30 is sized so that when the present bib 10 is worn by an infant, the opening 30 will be able to extend around, i.e. encircle, the infant's neck so that the bib 10 can be worn (as shown in FIGS. 3 and 4).

Preferably, the opening 30 has a circumference and/or diameter which is slightly less than the circumference and/or diameter of the widest portion of an infant user's head, in order to retain the bib 10 on the infant when being worn. Since the circumference of an infant human's neck is less than the circumference of his or her head, the panel 15 must be provided with a means for widening the circumference of the circumferential edge 32 when the bib 10 is being placed over an infant's head in order to be worn. This can be accomplished with a slit 34 which extends from the circumferential edge 32 of the opening 30 outwardly to or toward one lateral side of the present bib 10 (to either the first lateral side 12 or second lateral side 14).

The slit 34 can fully or partially separate a front portion 36 on one lateral side of the present bib 10 from a rear portion 38 on the other longitudinal side of the bib 10. In fully or partially separable embodiments, the extension slit 34 can, for example, be a perforation line 40. In some embodiments, the panel 15 can be provided with a plurality of slits forming a series of perforations 42 between the upper surface 22 and lower surface 24 of the panel 15. The material between such perforations 42 can be separated by an adult user 50 of the present burping bib 10 to form a single slit 40 which fully or partially separates the front portion 36 from the rear portion 38 of the panel. In some embodiments, a slit 34 can extend longitudinally. In other embodiments, a plurality of slits can be provided, but in this case only one at most may extend completely to a lateral side of the bib 10.

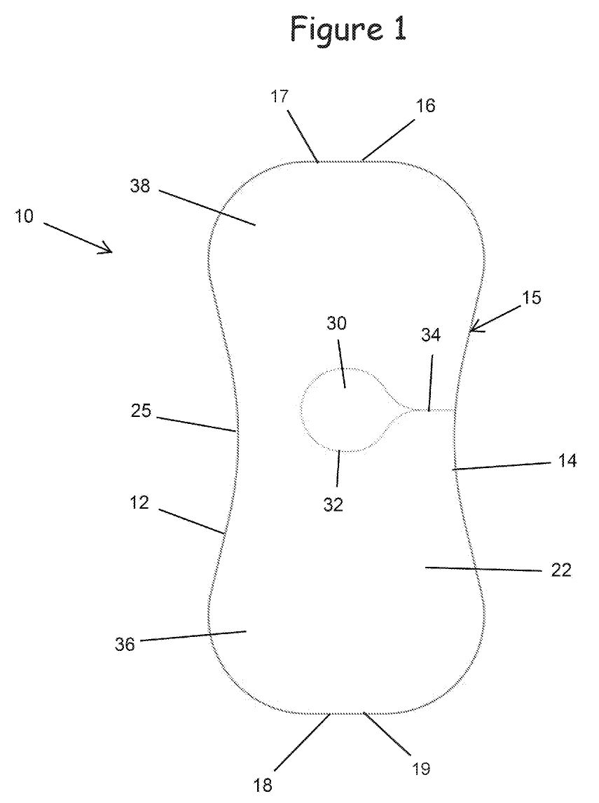

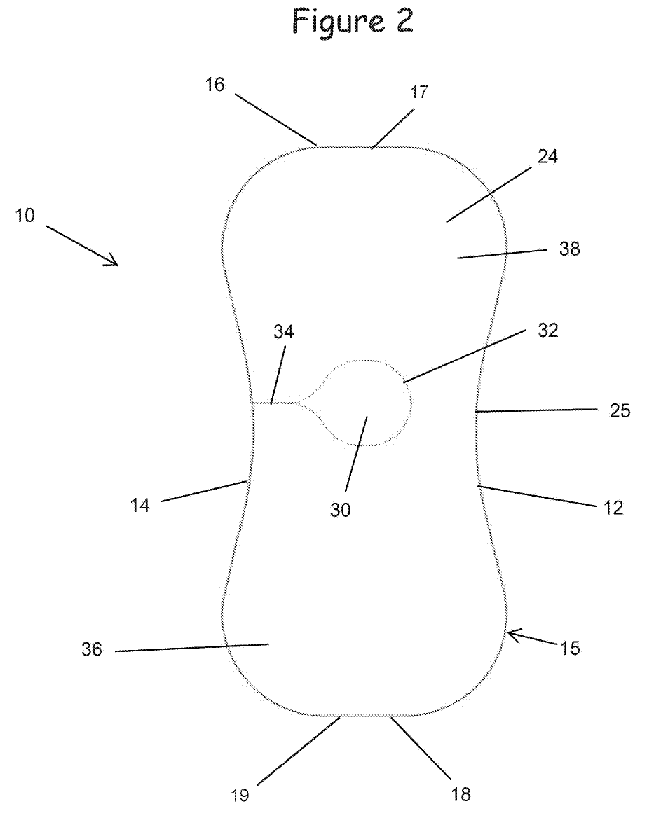

In a preferred embodiment, the bib is asymmetrical along its longitudinal axis such that the central opening 30 is not in the center of the panel 15, i.e. so that the distance from the circumferential edge 32 (of from the center of the opening 30) to the top edge 17 of the first longitudinal side 16 is different than the distance from the circumferential edge 32 (or center of the opening 30) to the bottom edge 19 of the second longitudinal side 18. This allows the use of the present bib 10 for a longer period of time, as the shorter side can be placed in the front of an infant when the infant is smaller, and the longer side can be placed in the front as the baby grows. In the embodiment of FIGS. 1 and 2, the first longitudinal side 16 is shorter than the second longitudinal side 18.

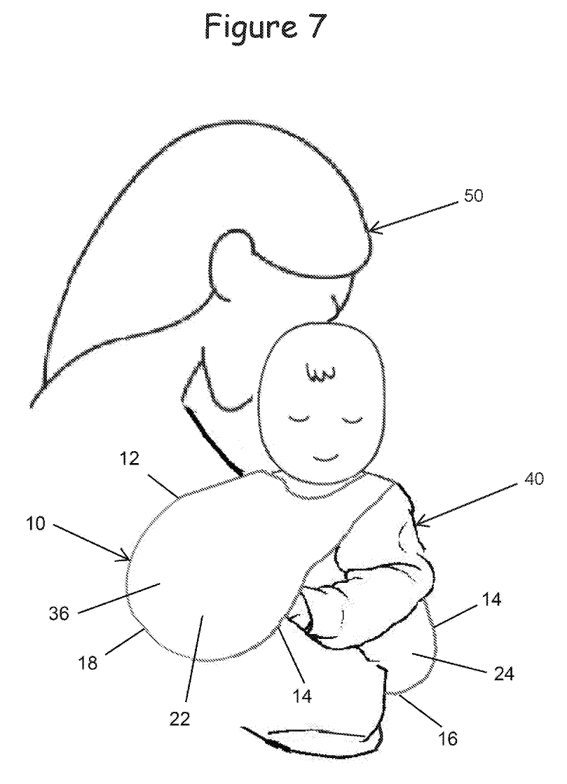

Alternatively, the shorter side of the present burping bib 10 can be used as a bib when feeding an infant user 40, i.e. placed in front of the infant 40 during feeding. When the infant 40 is in need of burping, the burping bib 10 can be rotated around the infant's neck so that the shorter side covers the infant's back and the longer side is in front. The longer side can then be draped over the back of a caretaker 50 engaged in burping the infant 40, as shown in FIG. 7.

With reference to FIG. 3, in this embodiment the top edge 17 of the rear portion 38 can be separated from the circumferential edge 32 by a distance D1 of between about 4 inches and about 12 inches, or between about 5 inches and about 9 inches, or by about 6 inches. The bottom edge 19 of front portion 36 can be separated from the circumferential edge 32 by a distance D2 of between about 5 inches and about 15 inches, or between about 7 inches and about 12 inches, or by about 8 inches. In this embodiment, the longitudinal extent of the front portion 36 (D2) is greater than the longitudinal extent of the rear portion (D1) by between about 20% and about 30%, such as by about 25%.

The central portion 25 preferably has a narrower width than the top edge 17 and bottom edge 19, as shown in FIG. 3. The circumferential edge 32 can have a diameter D5 of between about 4 inches and about 6 inches, or can be about 5 inches. The distance D3 between the circumferential edge 32 and a panel edge on the right side 12 or left side 14 can be between about 1.5 inches and 3 inches, or can be about 2 inches. The slit in these embodiments can have an extent D4 of between about 1 inch and about 3 inches, or between about 1.5 and about 2 inches, or about 1.75 inches.

In another embodiment, the present article can be symmetrically shaped, i.e. symmetrical around an axis in the center portion 25 extending from the first lateral side 12 to the second lateral side 14, so that the bib 10 can be put on an infant and be equally effective in protecting the infant and/or a caregiver regardless of which side is chosen to be worn on the front or back of the infant. In this embodiment, both ends of the burping bib would be sized like the front portion 36 described above.

The present article is preferably formed from a single piece of material, though embodiments in which different pieces of material are stitched, glued, or otherwise attached together to form the present article are possible. A variety of materials can be used to form the present article, though the use or inclusion of an absorbent material, such as paper or fiber, is preferred. In some embodiments, a multi-ply or layered material can be used in order to provide the advantages of different materials. For example, a two or more layer material for use with the present article can comprise an absorbent layer, such as a layer of woven material capable of wicking liquids, bonded to a layer of water resistant or liquid impermeable material, such as a nonwoven material like polypropylene. Preferably, the absorbent material faces the upper surface 22 of the bib 10 and the water-resistant material faces the lower surface 24 when the bib 10 is worn by an infant. The materials used are preferably sufficiently strong to be useful as a bib and burp cloth, but sufficiently compactible so as to be disposable following use.

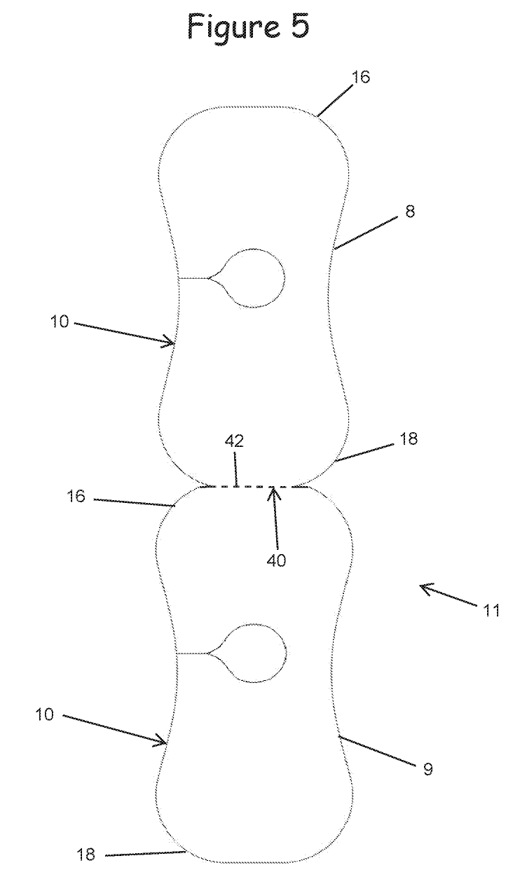

The present burping bib 10 can be provided as a single sheet, as shown in FIGS. 1-4, or can be provided in a joined manner as an assembly 11 as shown in FIG. 5. In the embodiment of FIG. 5, a first sheet 8 is joined to a second sheet 9 along a perforation line 40. The material between perforations 42 can be ripped or cut in order to separate the first sheet 8 from the second sheet 9 to form two separate burping bibs 10. An assembly of burping bibs 10 can be provided in a folded manner or can be joined in series, in which case the bibs 10 can be wound or wrapped around a spindle in the manner of a roll, such as a roll of paper towels.

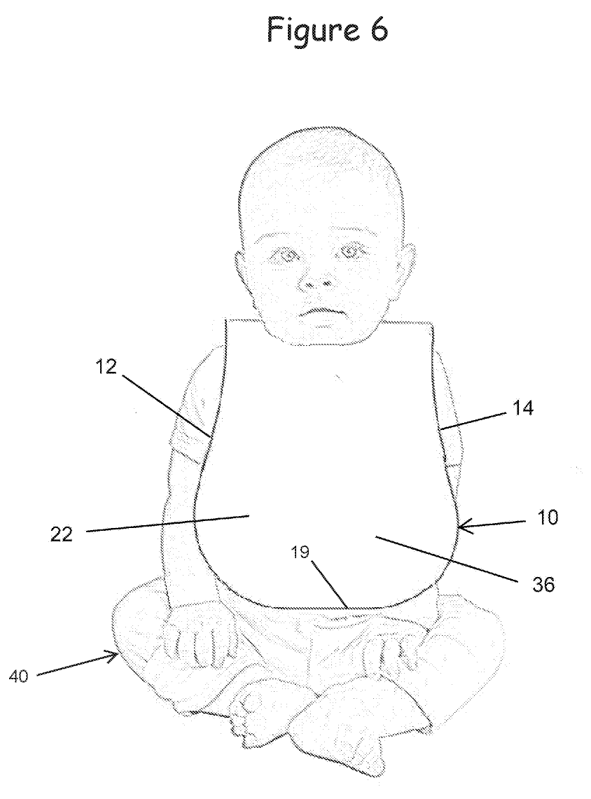

When used as a bib, the present bib 10 is worn by an infant as shown in FIG. 6. In this case, the infant's head is placed through the center opening 30, and either the first portion 36 or the second portion 38 is placed over the front of the infant. When used as a burping cloth, the present bib 10 can simply be placed over a caregiver's shoulder and used as a burping cloth in a conventional manner, as shown in FIG. 7. Alternatively, the bib 10 can be retained on an infant in the manner of a bib, and the portion of the bib 10 being worn on the front of the infant can be placed over the caregiver's shoulder, as shown in FIG. 4.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure.

Recitation of value ranges herein is merely intended to serve as a shorthand method for referring individually to each separate value falling within the range. Unless otherwise indicated herein, each individual value is incorporated into the specification as if it were individually recited herein. All references cited herein are incorporated by reference in their entirety.

What is claimed is:

1. A burping bib formed from an elongated panel formed from a piece of flexible material, the bib having a right side, a left side, a top end with a top edge, a bottom end with a bottom edge, an upper surface, a lower surface, a front portion, a central portion, and a rear portion, wherein:
(a) the central portion comprises an opening, the opening having a circumferential edge sized to accommodate the neck of an infant user and a slit between the opening and the right side or left side of the panel;
(b) the rear portion extends longitudinally from the top edge of the panel to the circumferential edge of the opening of the central portion, the top edge being separated from the circumferential edge by a distance of between about 4 inches and about 12 inches; and
(c) the front portion extends longitudinally from the bottom edge of the panel to the circumferential edge of the opening of the central portion, the bottom edge being separated from the circumferential edge by a distance of between about 5 inches and about 15 inches; and
wherein the longitudinal extent of the front portion is greater than the longitudinal extent of the rear portion by between about 20% and about 30%.

2. The burping bib of claim 1, wherein the top edge is separated from the circumferential edge by a distance of between about 5 inches and about 9 inches.

3. The burping bib of claim 1, wherein the top edge is separated from the circumferential edge by a distance of about 6 inches.

4. The burping bib of claim 1, wherein the bottom edge is separated from the circumferential edge by a distance of between about 7 inches and about 12 inches.

5. The burping bib of claim 1, wherein the bottom edge is separated from the circumferential edge by a distance of between about 8 inches.

6. The burping bib of claim 1, wherein the circumferential edge has a diameter of about 5 inches.

7. The burping bib of claim 1, further comprising a plurality of slits between the opening and the right side or left side of the panel.

8. The burping bib of claim 1, wherein the panel includes only radiused edges.

9. The burping bib of claim 1, wherein the lower side of the panel has a width greater than a width of the central portion.

10. The burping bib of claim 1, wherein the upper side of the panel has a width greater than a width of the central portion.

11. The burping bib of claim 1, wherein the panel comprises an absorbent material.

12. The burping bib of claim 1, wherein the panel comprises an upper layer at the upper surface of the panel and a lower layer at a lower surface of the panel, and wherein the upper layer is made from an absorbent material and the lower layer is made from a water-resistant material.

13. An assembly of burping bibs comprising a plurality of the burping bibs according to claim 1, wherein each of the bibs is joined to at least one other bib.

14. The assembly of claim 13, wherein the bibs are joined in series.

15. The assembly of claim 14, wherein the series of bibs are wound around a spindle to form a roll of bibs.
